(19) United States
(12) Patent Application Publication
(10) Pub. No.: US 2026/0346502 A1
(43) Pub. Date: Nov. 5, 2026

(54) SURFACE SAWING EQUIPMENT WITH A DISTANCE METERING ARRANGEMENT

(71) Applicant: HUSQVARNA AB, Huskvarna (SE)

(72) Inventors: Johan SANDWALL, Grabo (SE); Tobias GUSTAFSSON, Goteborg (SE)

(21) Appl. No.: 19/120,786

(22) PCT Filed: Oct. 18, 2023
(86) PCT No.: PCT/EP2023/079020

§ 371 Date: Apr. 13, 2025

(30) Foreign Application Priority Data
Oct. 20, 2022 (SE) 2251226-3

(51) Int. Cl. B28D 1/04; B28D 7/00; G01B 3/12

(52) U.S. Cl. CPC B28D 1/045; B28D 7/005; G01B 3/12

(57) ABSTRACT

A surface saw (100) for sawing in a surface (160), the surface saw comprising a circular cutting blade (110), a control unit (130), and at least one metering wheel (120, 170, 310, 400, 450), where the metering wheel (120, 170, 310, 400, 450) is arranged to rollably contact the surface (160) and to output a signal indicative of a distance (D) travelled by the surface saw (100) during operation of the surface saw (100), where the control unit (130) is arranged to receive the signal from the metering wheel (120, 170, 310, 400, 450), and to record the travelled distance (D) by the surface saw (100) during operation of the surface saw (100).

### TECHNICAL FIELD

The present disclosure relates to construction equipment for concrete processing and in particular to early entry concrete saws, floor saws, and road saws. There are disclosed surface saws, control units and methods which allow determination of a productivity level by the saw, based on a measurement of a sawed distance and on an associated elapsed time period.

### BACKGROUND

Road saws and floor saws are construction equipment by which a hard surface can be cut, e.g., as part of a construction project. Road saws can, for instance, be used to saw through concrete surfaces and asphalt surfaces.

Early entry concrete sawing is a concrete processing technique where shallow cuts, often in straight lines, are made in concrete surfaces within the first one or two hours after finishing surface preparation, i.e., after the concrete has reached a certain level of maturity but before the concrete has set completely, a period often referred to as the “green zone”. The shallow cuts create a weakened surface plane, thus encouraging cracking to occur at the location of the cuts in a controlled manner rather than the cracks appearing elsewhere in the concrete, resulting in a more visually appealing surface. One example of early entry concrete saws is the Soff-Cut range of early entry concrete saw products manufactured by Husqvarna AB.

During surface sawing, it is desired to feed the circular saw blade at a suitable speed through the surface material.

Sawing always causes saw blade wear. It is desired to obtain an indication of when a saw blade needs replacing by a new saw blade.

There is a need for surface saws such as early entry concrete surface saws, road saws, and other types of surface saws which promote efficient use.

### SUMMARY

It is an object of the present disclosure to provide improved surface saws which alleviate at least some of the issues mentioned above. The object is at least in part obtained by a surface saw for sawing in a surface, such as a concrete floor or an asphalt road. The surface saw comprises a circular cutting blade, a control unit, and at least one metering wheel. The metering wheel is arranged to rollably contact the surface and to output a signal indicative of a distance travelled by the surface saw during operation of the surface saw. The control unit is arranged to receive the signal from the metering wheel, and to record the travelled distance by the surface saw during operation of the surface saw. The control unit also comprises a clock or timer circuit, which allows for determination of a current productivity level of the surface saw, which productivity level is indicative of a travelled distance per unit of time. The current productivity level of the saw is determined based on the recorded travelled distance and on an associated elapsed period of time. The productivity level of the surface saw is preferably determined as an average travelled distance per unit of time determined over a given time period or over a given distance. This type of average travelled distance per unit of time is more reliable than an instantaneous speed of the surface saw, which may vary significantly during a work task or during a part of a work task.

By keeping track of travelled distance and on associated time periods in this manner, several improvements to the operation and feature set of the surface saw are enabled. The control unit may, e.g., be configured to determine blade wear based on measured decrease in productivity level over time, which is an advantage. The control unit can be configured to control a user interface on the surface saw and/or to communicate with external equipment, thus distributing the obtained data on travelled distance to an operator or remote system. This allows a plurality of applications to be realized, promoting both efficiency and ease of use. The control unit can, e.g., be set up to determine a distance remaining until work task completion, and also a time remaining until work task completion based on the current productivity level of the saw.

Having access to productivity level information enables an operator to quickly discover if something is amiss during a work task, such that corrective measures can be taken to restore productivity to the expected level. This way sawing work at construction sites can be maintained at high efficiency. A saw blade on a given surface saw may, e.g., have become too worn down to allow operation at a reasonable productivity level. By measuring productivity level and comparing this measured productivity level to an expected productivity level for a given work step, such worn down saw blades can be identified, and corrective action can be taken to restore productivity.

A user interface of the surface saw can be used to indicate the current productivity level. The control unit can also be arranged to determine a difference between the current productivity level and an expected productivity level of the surface saw, and to trigger a notification in case the difference does not meet an acceptance criterion. Thus, in case the surface saw travels too slowly or too fast over the surface, the operator is made aware of the fact and can take appropriate action. The discrepancy in productivity by the surface saw may, e.g., be due to a damaged saw blade, a saw blade of the wrong type, excessive saw blade wear, or that the sawing operation was not started in time before the surface had time to mature to a hard surface.

According to some aspects, the control unit is arranged to determine a difference between the current productivity level and an expected productivity level, and to trigger a saw blade conditioning operation in case the difference between the current productivity level and the expected productivity level does not satisfy an acceptance criterion such as a threshold or acceptance range. The saw blade conditioning operation may comprise controlling an electric drive motor of the surface saw to generate a vibration, temporarily changing rotation direction of the saw blade, or changing a drive torque. This saw blade conditioning operation may improve the productivity level of the surface saw by mitigating effects of saw blade glazing. A saw blade conditioning operation is performed in order to expose new fresh diamonds on a diamond saw blade, which, e.g., mitigates effects of glazing on the saw blade cutting segments.

The control unit may also be arranged to control a drive unit of the surface saw based on the difference between the current productivity level and the expected productivity level, i.e., to compensate for the discrepancy in productivity level by increasing or decreasing a drive unit power to speed up or to slow down the saw. This allows automated optimization of the sawing operation, which is an advantage. The expected productivity level can be configured in dependence of a circular cutting blade type mounted to the surface saw and/or in dependence of a current work task and/or in dependence of a maturity level of a concrete material in the surface, as will be discussed in more detail below. It is an advantage that the expected productivity level can be customized to a given work task, and to a given set of work site conditions. The metering wheel arranged on the surface saw is preferably an undriven wheel, since an undriven wheel is less likely to slip relative to the surface as a driven wheel sometimes does. The metering wheel may also be biased against the surface, i.e., actively pressed against the surface, in order to reduce slip between wheel and surface as the surface saw travels over the surface.

According to some aspects of the disclosure, the metering wheel is arranged to only make contact with the ground when the circular cutting blade is lowered into the ground or when the surface saw is activated. This can, e.g., be achieved using a metering wheel arranged on an actuated arm, or the like. The control unit can be arranged to control the actuator which places the metering wheel in contact with the surface.

The clock or timer circuit used to measure the elapsed time period of a sawing operation is preferably paused when the surface saw is not actively sawing, i.e., when the saw blade is raised above ground and/or when the saw blade is not active.

One or more metering wheels can be arranged on a surface saw. At least one of these metering wheels can be configured with a rolling surface which increases friction relative to the surface. Examples of such friction increasing surfaces include, e.g., spikes, a protruding chevron pattern, and various resilient coatings, such as a rubber coating which promotes friction between wheel and surface.

Some surface saws comprise a guide wheel which is used by the operator of the surface saw to maintain a straight cutting line. The metering wheel of the present disclosure can be integrated with this guide wheel. The at least one metering wheel may also comprise a supporting wheel of the surface saw. Thus, existing wheels on a surface saw can be re-used with advantage to realize the metering wheel required by the herein disclosed techniques. A guide wheel is often arranged at the distal end of a guide wheel arm. This guide wheel arm can be actuated such that the metering wheel can be manually or automatically raised from and lowered to the surface to be processed. Thus travelled distance will only be recorded as the surface saw is in operation, and not during transportation of the floor saw.

According to some aspects, the at least one metering wheel comprises a ferrous metal part and a Hall effect sensor arranged to detect passage of the ferrous metal part and to output the signal indicative of the distance travelled by the surface saw to the control unit. This sensor arrangement has the associated advantage of being robust and relatively insensitive to dirt and water which is normally encountered during surface sawing. The metering wheel sensor arrangement may also comprise any of a photo diode, an inductive sensor, a rotary encoder, and/or a mechanical flip switch, arranged to output the signal indicative of the travelled distance to the control unit.

According to some aspects, the control unit is arranged to determine a current blade wear level as an increasing function of the recorded travelled distance by the surface saw and/or based on the current productivity level, where a decrease in productivity level over time may be taken as an indication of increased saw blade wear. Thus, as the circular cutting blade is used for cutting, the control unit keeps track of an expected level of blade wear by using a predetermined relationship between travelled distance and blade wear, i.e., an expected blade wear rate. An operator may then obtain information about current blade wear, which is an advantage. The operator can also be informed when it is time to replace the blade with a new blade or at least when it may be advisable to check the wear status of the saw blade currently mounted to the surface saw. This information may be provided to the user by a user interface arranged to indicate the current blade wear level by the user interface. The control unit can also be arranged to determine a remaining time and/or remaining distance until blade replacement based on the current blade wear level and based on a maximum blade wear level configuration. This blade wear determination can be improved if the control unit also knows about the surface material being processed by the cutting blade. A plurality of different surface materials can be configured in the control unit with associated blade wear rates, and the control unit can then obtain a current work material from an operator of the surface saw or from some other source, such as a remote server.

The surface saw may also comprise an angle and/or a tilt sensor arranged to output a signal indicative of an angle of a surface saw chassis relative to a horizontal plane. The control unit can then be arranged to determine if the surface saw is in operation based on the output from the angle and/or tilt sensor, and to record the travelled distance by the surface saw only if the surface saw is in operation. The clock or timer circuit used to record the elapsed time period discussed above is preferably also paused when the surface saw is not in operation. This way distances over which the saw is just transported without the saw blade being in operation are not recorded by the control unit and does not influence the determined productivity level. This is an advantage since it makes the recorded travelled distance and the determined productivity level more accurate. The control unit may of course also keep track of transportation distance in this manner, which could be of interest to some operators, e.g., operators wanting to investigate how much the saw is transported around at the work site compared to how much the saw is actually used for sawing. According to some aspects the productivity level that is determined by the control unit also comprises information indicative of how much time is spent actively sawing in relation to time where the surface saw is inactive, i.e., stationary or under transport from one work location to another work location on a construction site. This way inefficiencies in surface sawing at a work site can be identified and corrective action can be taken.

The surface saw optionally comprises an inertial measurement unit (IMU) arranged to output a signal indicative of a vibration of the surface saw. This allows the control unit to determine if the surface saw is in operation based on the output from the IMU, and to record the travelled distance by the surface saw only if the surface saw is in operation. The saw, when in use, shows significant vibration, which can be detected using the signal from the IMU. This is a reliable way to separate travelled distance during sawing operation from travelled distance during transportation. The surface saw may furthermore comprise a drive unit arranged to output a signal indicative of a torque applied to the circular saw blade and/or a signal indicative of a power consumption by the drive unit. The control unit can then be arranged to determine if the surface saw is in operation based on the torque output from the drive unit and/or based on the power consumption by the drive unit, and to record the travelled distance by the surface saw only if the surface saw is in operation. The elapsed time recorded by the clock or timer circuit can be adjusted to only account for time periods when the surface saw is in operation and sawed distance is being recorded.

According to some aspects the recorded time periods can also be tagged with information related to the type of operation by the surface saw, i.e., if the surface saw is stationary, under transport, or actively sawing.

According to other aspects, the control unit is arranged to transmit the recorded travelled distance by the surface saw and/or the current productivity level of the surface saw to a remote server (or at least the elapsed time period during which the travelled distance was recorded). This sharing of travelled distance data can be used at the remote server for, e.g., billing purposes, quality assurance, and also for monitoring work progress by the surface saw, which is an advantage. It is an advantage that productivity level can be shared in this manner between surface saw and remote server since it enables remote monitoring of productivity level.

There are also disclosed herein control units and methods associated with the advantages mentioned above.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1A, B show example concrete processing equipment;

FIG. 2 schematically illustrates a travelled distance by a surface saw;

FIG. 3 shows a surface saw with an example user interface;

FIG. 4A, B show example metering wheels;

FIG. 5 illustrates a surface saw with a tilt sensor;

FIG. 6 is a flow chart illustrating methods;

FIG. 7 schematically illustrates a control unit;

FIG. 8 schematically illustrates a computer program product;

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

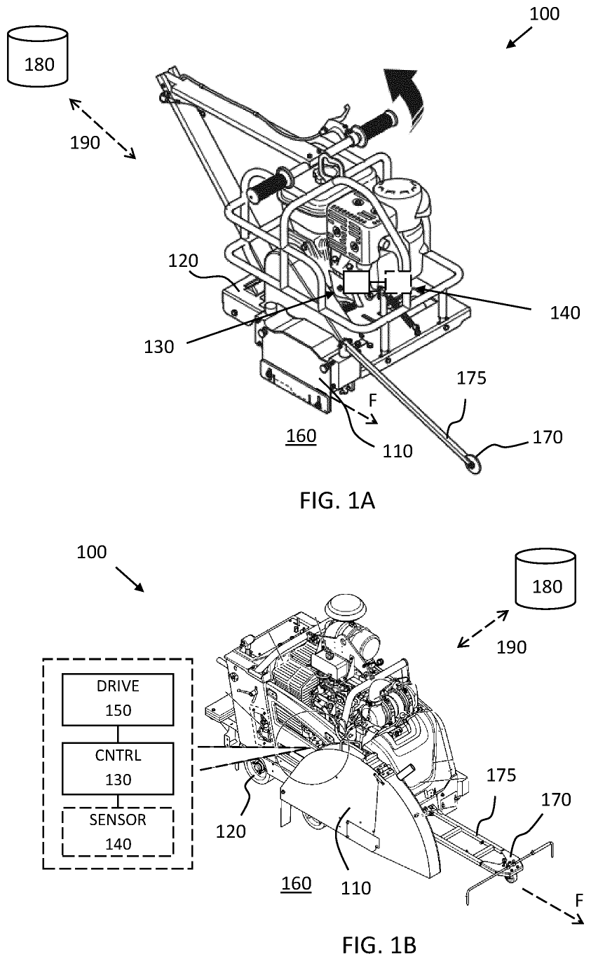

FIGS. 1A and 1B illustrate some example surface saws. A surface saw is a machine intended for sawing into a surface such as a floor or a road. The surface is normally horizontal but could also be associated with an incline. Early entry floor saws (also known as Soff-cut saws) and road saws are examples of surface saws. The thickness of the surface segment through which sawing by a surface saw is done varies, but is normally below 10-15 cm for an early entry saw while a floor saw may saw at depths up to about 70-80 cm.

A surface saw generally comprises a circular cutting blade 110 aligned with a forward direction F of the surface saw and driven by some form of drive unit 150. Thus, the forward direction is parallel to the cutting blade plane. The drive unit can be an electric machine or a combustion engine of some sort. Hybrid drive units are also possible, which comprise two or more driveline technologies, such as a combination of electric drive and combustion engine powered drive. The surface saw also comprises supporting wheels 120 to support the surface saw against the surface segment 160 to be cut. One or more of the supporting wheels may be driven wheels, which means that they are connected to a propulsion device, such as an electric machine or hydraulic drive, arranged to provide positive torque to the wheel in order to move the saw in the forward direction. One or more of the supporting wheels may also comprise respective wheel brakes arranged to provide negative torque to the wheel. It is appreciated that a surface saw may comprise one or more supporting wheels with respective wheel brakes even if there are no driven wheels, e.g., if the cutting blade rotation is used as sole means for propulsion.

The surface saws discussed herein also comprise a control unit 130 configured to control various functions on the surface saw, such as controlling the drive unit 150 which powers the saw blade 110. The control unit 130 may also control one or more driven support wheels of the surface saw. The control unit 130 bases its control of the surface saw functions at least partly based on an on-board sensor system 140, which may comprise one or more inertial measurement units (IMU), electronic spirit level sensors, tilt sensors, and also a metering wheel which measures a distance travelled by the surface saw over the surface 160 during the cutting operation. The data from the metering wheel can be used for various functions on the surface saw, such as determining a current blade wear level and for calculating a productivity level of the surface saw, e.g., in terms of meters sawed per unit of time or on a predetermined scale from a minimum productivity level to a maximum productivity level, such as a scale from 1-10. The current productivity level of the surface saw can also be quantified relative to a desired or expected productivity level, e.g., as a percentage of the desired or expected productivity level or as a signed value relative to the expected or desired productivity level. The user interface 320 in FIG. 3 illustrates an example of how current productivity level can be communicated to a user of a surface saw.

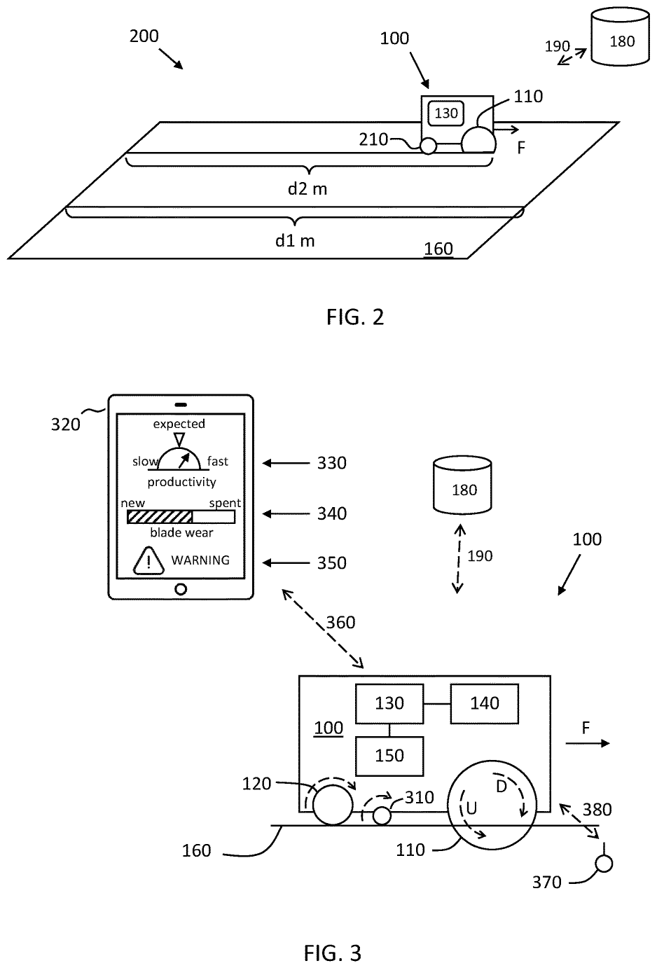

FIG. 2 schematically illustrates a surface sawing operation 200. A surface saw 100 has completed one cut of d1 m length and has sawed d2 m of a second cut. The current travelled distance D is the sum of the two cuts, i.e., D=d1+d2. The control unit 130 can use the metering wheel data to monitor this sawed distance. There is disclosed herein a surface saw 100 for sawing in a surface 160. The surface saw can, e.g., be an early entry concrete surface saw, a floor saw, or a road saw used in road construction projects. The surface saw comprises a circular cutting blade 110 driven by some form of drive unit 150, such as an electric machine, a hydraulic system, or a combustion engine. A combination of two or more power sources arranged in a hybrid drive unit is also possible. With reference also to FIG. 3, the cutting blade 110 may be configured for either down-cut D or up-cut U operation 230. Up-cut operation is common for early-entry saws such as the Soff-cut range of surface saws, while down-cut is more common on road saws and floor saws. The techniques disclosed herein are applicable for both down-cut as well as up-cut operation.

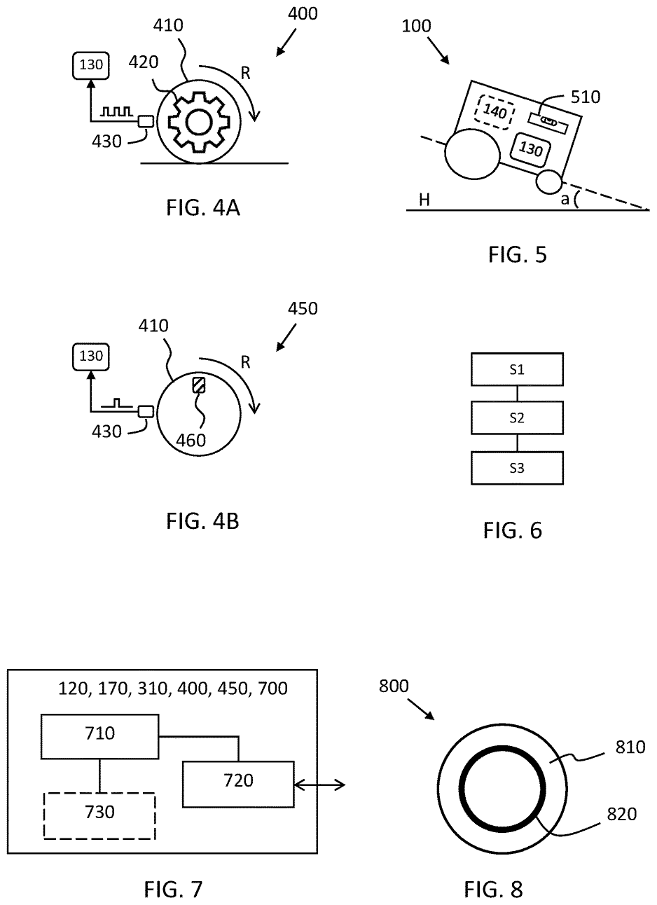

The surface saw 100 also comprises a control unit 130, and at least one metering wheel 120, 170, 310. This metering wheel 120, 170, 310, 400, 450 is arranged to rollably contact the surface 160 and to output a signal indicative of the distance D travelled by the surface saw 100 during operation of the surface saw 100. A metering wheel generally comprises some form of rolling member and also an associated sensor which measures rotation of the rolling member. Thus, as the surface saw moves over a surface such as a floor or a road, the metering wheel rolls a corresponding distance, and outputs a signal which indicates how many revolutions (or parts of revolutions for the more fine-grained encoders) that passes. Various forms of rotary encoders are possible to use in the metering wheel arrangement, some of which will be discussed below in connection to FIGS. 4A and 4B. One or more metering wheels can be used on a surface saw. If more than one wheel is used to measure travelled distance, then the occurrence of errors in a metering wheel arrangement can be detected, which is an advantage. For instance, if two metering wheels are used, and one wheel gets stuck or suffers some other form of malfunction, then the control unit 130 can detect the malfunctioning metering wheel since there will be a large difference between the signals from the two metering wheels.

The control unit and metering wheel arrangement preferably only records travelled distance only as the surface saw is actually sawing in the surface, and not during transportation of the surface saw. However, some aspects of the herein disclosed techniques will record travelled distance also during transport of the surface saw. In other words, transportation can in some cases be considered a form of operation by the surface saw. A reset function of the like can be used to remove the recorded distance accumulated during transportation. Corresponding elapsed time periods can be recorded by the control unit, i.e., time periods where the surface saw was transported and time periods where the surface saw was used for sawing can be recorded separately. These time periods can be used as basis for statistics related to overall productivity of a surface saw, i.e., how often a saw is actively used for sawing, how much of the total time that is spent for transporting the saw around in comparison to how much of the total time is spent actively sawing.

The surface saw 100 may be connected via data communication link 190 to a remote server 180, as illustrated in FIGS. 1A and 1B. The link 190 may be any of a wireless link, a wireline link, or a data communications link involving a data storage device such as a universal serial bus (USB) memory stick. This remote server may be arranged to monitor the work performed by the surface saw, such as the sawed distance per unit of time, i.e., the current productivity level, the total sawed distance during a given period of time, and so on. The remote server may also implement a billing system, as will be discussed in more detail below.

The surface saw may be performing a work task associated with a certain sawing distance, which distance is at least approximately known a-priori. According to some aspects the control unit 130 can be arranged to determine a remaining distance until work task completion, based on the recorded travelled distance D and on a predetermined work task sawing distance. The remaining distance until work task completion can then be indicated by the user interface 320. Data indicative of the remaining distance until work task completion can also be transmitted to a remote server 180. This enables advanced scheduling tasks to be implemented at the server, or at some other entity in communication with the server. This system can then keep track of progress at one or more construction sites, and predict when work tasks will be completed, since the system has access to sawing distances for each work task, and also to recorded travelled distance for each saw in, e.g., a fleet of saws. The control unit also comprises a clock or timer as discussed above and can therefore determine a productivity level in terms of, e.g., an average sawed distance per unit of time. This productivity level can then be used to determine approximately how much time remains until the predetermined work task sawing distance has been travelled by the saw. The estimated time remaining until work task completion can also be displayed to a user or communicated to the remote server 180.

The metering wheel 120, 170, 310, 400, 450 is preferably an undriven wheel of the surface saw. A driven wheel, i.e., a wheel where torque is applied to a wheel axle, normally slips against the surface during the sawing operation. This wheel slip, even if relatively small, causes underestimation of the travelled distance, which is undesired. In order to improve the accuracy of the signal from the metering wheel, the metering wheel 120, 170, 310, 400, 450 can be biased against the surface 160. This bias can, e.g., be obtained by spring-loading an arm which supports the metering wheel, such that a downwards force is applied to press the wheel against the surface. The biasing force can also be applied by adding weight to the wheel, such as if one of the surface saw supporting wheels 120 is used as the metering wheel.

According to other aspects, the metering wheel can be arranged to only contact the ground when the saw blade is in the sawing position, or even to only contact the ground during operation of the surface saw 100. This way a rotary encoder arranged in connection to the metering wheel will only record distance during sawing, and not during transportation of the saw. The metering wheel can, e.g., be configured with an actuator which automatically lowers the metering wheel to make contact with the surface when the saw is turned on. The metering wheel can also be arranged on an arm (as exemplified in FIGS. 1A and 1B) which can be mechanically linked to the saw blade raising mechanism of the saw 100, such that the metering wheel leaves the ground when the saw blade is lifted from its sawing position in the ground. A metering wheel 310 arranged in connection to the surface saw chassis, as exemplified in FIG. 3, can also be raised and lowered by some form of actuator, such as an electric actuator, a hydraulic actuator, or a manual mechanical actuator, possibly linked to a mechanical actuator used to raise and lower the circular cutting blade 110.

At least one metering wheel is optionally configured with a rolling surface which promotes friction between the rolling member of the metering wheel and the surface 160. This friction enhancing rolling surface may, e.g., comprise teeth or some other surface structure, e.g., a chevron pattern, which engage the surface to improve friction between wheel and surface. A resilient coating such as a rubber coating or the like can also be used with similar effect. This high friction rolling surface of the wheel reduces wheel slippage relative to the surface, and therefore improves the accuracy of the data obtained from the metering wheel.

The surface saws in FIGS. 1A and 1B both comprise front guide wheels 170. These small wheels are used to guide the saw in order to follow, e.g., a marking line on the surface to be sawed through. It may be advantageous to use this type of guiding wheel as the metering wheel. Some machines also comprise rear guide wheels which can be used with advantage as the metering wheel. The supporting arm 175 can also be used to generate the above-mentioned biasing force which presses the metering wheel against the surface to reduce slip of the metering wheel relative the surface 160.

According to some aspects the metering wheel is arranged to be lowered to the surface only when the saw is in its sawing position (lowered into the ground), this can be achieved by a mechanical link between metering wheel and surface saw chassis, such that the metering wheel is lowered together with the saw as it is lowered into its sawing position in the ground. An actuator can also be arranged in connection to the metering wheel to lower the metering wheel to the surface as the surface saw enters into its active operating state. This actuator can be controlled by the control unit. For instance, the control unit may be arranged to control an electric actuator attached to the arm 175 which holds the guidewheel, such that the guide wheel arm can be lowered to the surface when the circular cutting blade is lowered into the ground or when the drive unit of the surface saw is activated. This way travelled distance will only be recorded as the surface saw operates, and not when the surface saw is just being transported on the surface from one workplace to another workplace.

One or more of the surface saw supporting wheels 120 can also be used as metering wheel. An advantage of using one of the supporting wheels of the surface saw as metering wheel is that some weight from the surface saw is applied to the wheel in use, which reduces slippage between the metering wheel and the surface 160.

According to some aspects, with reference to FIGS. 4A and 4B, the at least one metering wheel 400, 450 comprises a ferrous metal part 420, 460 and a Hall effect sensor 430 arranged to detect passage of the ferrous metal part and to output the signal indicative of the distance D travelled by the surface saw 100 to the control unit 130. Thus, as the wheel rotates the Hall sensor outputs a signal with pulses indicative of the rotation of the wheel. The control unit 130, having regard to the wheel diameter, may then determine the travelled distance from the number of output pulses by the Hall effect sensor. The rolling member dimension of the metering wheel arrangement can be pre-configured in the control unit 130 or determined by calibration. An operator may, for instance, move the surface saw for a known distance and thus calibrate the metering wheel arrangement.

The at least one metering wheel may of course also comprise any of a photo diode, an inductive sensor, a rotary encoder, and/or a mechanical flip switch, arranged to output the signal indicative of the travelled distance D to the control unit 130. A photo diode could, for instance, be used to detect passage of one or more holes formed in the rolling member of the metering wheel arrangement. An inductive sensor detects a rotation by reacting to ferromagnetic or electrically conducting metal in the rotary member of the metering wheel arrangement, using one or more coils.

The control unit 130 is arranged to receive the signal from the metering wheel 120, 170, 310, 400, 450, and to record the travelled distance D by the surface saw 100 during operation of the surface saw 100.

The control unit 130, having recorded the distance travelled by the surface saw and also the productivity level over time, can optionally be arranged to determine a current blade wear level as an increasing function of the recorded travelled distance D by the surface saw 100 and/or based on the recorded productivity level, where a decrease in productivity level can be taken as an indication of increased blade wear. The mapping between productivity level or change in productivity level and blade wear can be determined by computer simulation and/or by practical experimentation using different types of saw blades applied in different surface sawing work tasks. The control unit 130 can, for instance, be configured with a blade type specific function by which a travelled distance and/or productivity level can be translated into an equivalent blade wear. This function can, for example be realized as a look-up table determined from experimentation or from some form of computer simulation of various types of circular cutting blades. The determined blade wear by the control unit 130 is preferably reset when a new blade is mounted to the surface saw. The control unit 130 can also maintain two or more travelled distances in memory and associate each such traveled distance with a given saw blade unit. The operator can then configure the control unit 130 with information about which saw blade unit that is currently mounted to the surface saw, and the control unit can then accumulate the corresponding travelled distance, in order to keep track of the distance sawed by each saw blade unit in its memory. The control unit can also be configured with data about the type of concrete or other material which is being processed by the saw blade. This data can then be used to arrive at a more accurate estimate of saw blade wear by the control unit. Some materials wear down the sawing blade faster than other materials. Hence, by configuring wear rates for a plurality of surface materials by the control unit, and obtaining data indicative of a current material, the control unit can improve the blade wear estimation. The data on wear rates for different materials can be obtained directly from a user of the machine or from the remote server 180. The data can also be pre-configured in the control unit at the factory. The estimation of blade wear is normally improved if the control unit bases the estimate of blade wear on both travelled distance and productivity level, and in particular a measured decrease in productivity level of the surface saw over time.

According to some aspects, the control unit is arranged to determine a difference between the current productivity level and an expected productivity level, and to trigger a saw blade conditioning operation in case the difference between the current productivity level and the expected productivity level does not satisfy an acceptance criterion such as a threshold or acceptance range. This acceptance criterion can be determined by computer simulation and/or by practical experimentation. The saw blade conditioning operation may comprise controlling an electric drive motor of the surface saw to generate a vibration, temporarily changing rotation direction of the saw blade, or changing a drive torque by the drive motor. This saw blade conditioning operation may improve the productivity level of the surface saw by mitigating effects of saw blade glazing. A saw blade conditioning operation may expose new fresh diamonds on a diamond saw blade, thereby improving the efficiency of the surface saw.

According to some aspects, the surface saw 100 also comprises a user interface 320, exemplified in FIG. 3. This user interface may be a separate device, such as a smart phone or a tablet, or a display mounted directly to the surface saw. The control unit 130 can then be arranged to indicate the current blade wear level 340 by the user interface 320, and an operator can obtain information about the current blade wear, and also how long time that remains until the blade needs to be replaced, i.e., according to some aspects the control unit 130 is arranged to determine a remaining time and/or remaining distance until blade replacement based on the current blade wear level and based on a maximum blade wear level configuration, which can be pre-configured or configured in use by an operator.

The control unit 130 comprises a clock or timer circuit as discussed above. This means that the control unit 130 can determine a current productivity level of the surface saw 100 based on the recorded travelled distance D and on an associated elapsed period of time, where the productivity level is indicative of a travelled distance per unit of time, such as an average speed of the surface saw. This productivity level indicates how fast the surface saw saws through the surface. The productivity level is normally associated with a desired productivity level, according to some form of optimality criterion, such as work progress, blade wear, or saw cut quality. The control unit 130 may be arranged to indicate the current productivity level 330 by the user interface 320, as illustrated in FIG. 3. An operator, having regard to the current productivity level, may adjust the operation of the surface saw to come closer to the desired productivity level. This desired productivity level may, e.g., be pre-configured in the control unit as a function of cutting blade type, work task, and the like.

The productivity level is preferably averaged over a given sawed distance and/or over a given time period in order to smooth out variation in the speed of the surface saw which occurs naturally during most surface sawing work tasks. The instantaneous speed of the surface saw, as it moves over a surface, often varies, and thus an averaged metric is more suitable than an instantaneous speed metric which can be expected to fluctuate too much to be useful. The average can be determined as a moving average over a given time window, a weighted moving time average which comprises a forgetting factor to emphasize more recent instantaneous sawing speed, or the like.

FIG. 3 also shows a concrete maturity sensor 370 arranged to continuously or periodically measure moisture and/or temperature in the material of the surface 160 and communicate this data via wireless link 380 to the control unit 130. This maturity data can be used to optimize surface saw control by determining a suitable productivity level in terms of meters of progress per unit of time. It is appreciated that concrete slabs become harder as they mature. Thus, a concrete maturity level can be translated into a concrete hardness level and vice versa. This type of conversion can be made using a look-up table or the like. It is appreciated that the translation between maturity and hardness may be dependent on the type of concrete, i.e., on the concrete recipe. Thus, it is appreciated that concrete maturity level and concrete hardness are often at least approximately equivalent in terms of information content. The concrete hardness in a surface to be cut can be used by the control unit 130 to determine the desired productivity level, possibly based also on the type of saw blade which is mounted to the machine. In other words, if the control unit knows how hard the surface is, and perhaps also which type of blade and machine that is being used, then it can determine what the productivity level should be if all aspects of the operation is as they should. If something is wrong, such as a worn saw blade or drive unit malfunction, then the productivity level will decrease below the expected level. If this happens a notification can be triggered such that corrective action can be taken. A saw blade conditioning operation or saw blade replacement operation can, for instance, be performed in order to restore productivity level to the expected level given the conditions at the work site.

As mentioned above, the control unit 130 can be arranged to determine a difference between the current productivity level 330 and an expected productivity level, and to trigger a notification 350 in case the difference does not meet an acceptance criterion, as illustrated in FIG. 3. This way an operator can receive information if the current productivity level is sub-optimal, either because the saw is moving too fast over the surface or too slow over the surface. The control unit 130 is optionally also arranged to control the drive unit 150 of the surface saw 100 based on the difference between the current productivity level and the expected productivity level. This way the control unit can control the drive unit to increase or decrease the productivity level in order to obtain a desired productivity level. The desired productivity level can be set as a function of the specific work task, i.e., which material is being cut, how deep the cut is, and so on, and also in dependence of the type of saw blade that is used. The maturity level and material composition of a concrete surface can of course also be accounted for when determining the target productivity level to strive for. The control unit can also obtain data indicate of a current load (e.g., from a load sensor or indirectly via consumed current) on the drive unit 150, and compare this load to the current productivity level. This data can then be communicated to a user of the machine, or to the remote server 180.

The surface saw 100 may furthermore comprise an angle and/or a tilt sensor 510, as illustrated in FIG. 5, arranged to output a signal indicative of an angle a of a surface saw chassis relative to a horizontal plane H. The control unit 130 may then determine if the surface saw is in operation based on the output from the angle and/or tilt sensor 510, and to record the travelled distance D by the surface saw 100 only if the surface saw is in operation. Thus, if the operator lifts the saw blade into the air in order to, e.g., transport the surface saw from one location to another, then the control unit can cease recording the travelled distance by the surface saw. The surface saw 100 may also comprise an IMU 140 arranged to output a signal indicative of a vibration of the surface saw. The control unit 130 can then determine if the surface saw is in operation based on the output from the IMU (since it vibrates in a different way in use compared to under transport), and to record the travelled distance D by the surface saw 100 only if the surface saw is in operation. The recording of elapsed time periods is preferably paused, or at least tagged correspondingly, when the surface saw is not in operation.

The surface saw 100 optionally comprises a drive unit 150 arranged to output a signal indicative of a torque applied to the circular saw blade 110. In this case the control unit 130 can be arranged to determine if the surface saw is in operation based on the torque output from the drive unit, and to record the travelled distance D by the surface saw 100 only if the surface saw is in operation. The power consumption (such as a drawn current) by the drive unit 150 can also be used to determine if the saw is in operation.

A surface sawing work task is sometimes billed according to sawed distance, i.e., as a fixed cost per unit of distance travelled by the saw during a sawing operation. The metering wheel arrangements discussed above can be used also for the purpose of billing assistance or even automated billing, which is an advantage. The control unit 130 then keeps track of the distance D travelled by the surface saw 100 during operation of the surface saw 100 during a project performed for a given customer. The control unit 130 may then transmit the distance data to a billing system or the like.

FIG. 1 schematically illustrates a remote server 180 which may implement a billing system. The control unit 130 may be configured to transmit data indicative of the recorded travelled distance to this remote server 180, e.g., via wireless link 190. The remote server can also implement a quality assurance system, which keeps track of sawed distance at a given work site and compares the sawed distance to an expected sawed distance. In case there is a discrepancy between the two, a notification can be triggered. This way a work quality receipt can be generated, which states that the sawing task has been completed according to specification.

FIG. 6 is a flow chart illustrating methods which summarize some of the above discussion. Most of the technical details discussed above are applicable also together with the methods. There is illustrated a computer-implemented method performed by a control unit 130 arranged in a surface saw 100 for sawing in a surface 160. The surface saw comprises a circular cutting blade 110 and at least one metering wheel 120, 170, 310, 400, 450. The method comprises arranging S1 the metering wheel 120, 170, 310, 400, 450 to rollably contact the surface 160 and to output a signal indicative of a distance D travelled by the surface saw 100 during operation of the surface saw 100, receiving S2, by the control unit 130, the signal from the metering wheel 120, 170, 310, 400, 450, and recording S3, by the control unit 130, the travelled distance D by the surface saw 100 during operation of the surface saw 100. The method also comprises determining a current productivity level of the surface saw 100, by the control unit 130, where the current productivity level is indicative of a travelled distance per unit of time, based on the recorded travelled distance D and on an associated elapsed period of time determined by a clock or timer circuit of the control unit 130.

FIG. 7 schematically illustrates, in terms of a number of functional units, the general components of a control unit 700, such as the circuits and arrangements 120, 170, 310, 400, and 450 discussed above. Processing circuitry 710 is provided using any combination of one or more of a suitable central processing unit CPU, multiprocessor, microcontroller, digital signal processor DSP, etc., capable of executing software instructions stored in a computer program product, e.g., in the form of a storage medium 730. The processing circuitry 710 may further be provided as at least one application specific integrated circuit ASIC, or field programmable gate array FPGA.

Particularly, the processing circuitry 710 is configured to cause the device 700 to perform a set of operations, or steps, such as the methods discussed in connection to FIG. 6 and the discussions above. For example, the storage medium 730 may store the set of operations, and the processing circuitry 710 may be configured to retrieve the set of operations from the storage medium 730 to cause the device to perform the set of operations. The set of operations may be provided as a set of executable instructions. Thus, the processing circuitry 710 is thereby arranged to execute methods as herein disclosed.

The storage medium 730 may also comprise persistent storage, which, for example, can be any single one or combination of magnetic memory, optical memory, solid state memory or even remotely mounted memory.

The device 700 may further comprise an interface 720 for communications with at least one external device, such as the user interface 320. As such the interface 720 may comprise one or more transmitters and receivers, comprising analogue and digital components and a suitable number of ports for wireline or wireless communication.

The processing circuitry 710 controls the general operation of the control unit 700, e.g., by sending data and control signals to the interface 720 and the storage medium 730, by receiving data and reports from the interface 720, and by retrieving data and instructions from the storage medium 730.

FIG. 8 illustrates a computer readable medium 810 carrying a computer program comprising program code means 820 for performing the methods illustrated in FIG. 6, when said program product is run on a computer. The computer readable medium and the code means may together form a computer program product 800.

1. A surface saw for sawing in a surface
the surface saw comprising a circular cutting blade a control unit, and at least one metering wheel,
wherein the metering wheel arranged to rollably contact the surface and to output a signal indicative of a distance travelled by the surface saw during operation of the surface saw,
wherein the control unit is arranged to receive the signal from the metering wheel and to record the travelled distance by the surface saw during operation of the surface saw,
the control unit further comprising a clock or timer circuit, wherein the control unit is arranged to determine a current productivity level of the surface saw indicative of a travelled distance per unit of time, based on the recorded travelled distance and on an associated elapsed period of time.

2. The surface saw according to claim 1, wherein the metering wheel is an undriven wheel.

3. The surface saw according to claim 1, wherein the metering wheel is biased against the surface

4. The surface saw according to claim 1,
wherein the at least one metering wheel has a rolling surface configured for increased friction relative to the surface.

5. The surface saw according to claim 1, wherein the at least one metering wheel comprises a guide wheel of the surface saw.

6. The surface saw according to claim 1, wherein the at least one metering wheel comprises a supporting wheel of the surface saw

7. The surface saw according to claim 1, wherein the at least one metering wheel comprises a ferrous metal part and a Hall effect sensor arranged to detect passage of the ferrous metal part and to output the signal indicative of the distance travelled by the surface saw to the control unit.

8. The surface saw according to claim 1, wherein the at least one metering wheel comprises any of a photo diode, an inductive sensor, a rotary encoder, and/or a mechanical flip switch, arranged to output the signal indicative of the travelled distance to the control unit.

9. The surface saw according to claim 1, wherein the control unit is arranged to determine a current blade wear level as an increasing function of the recorded travelled distance by the surface saw and/or based on the current productivity level.

10. (canceled)

11. The surface saw according to claim 9, wherein the control unit is arranged to determine a remaining time and/or remaining distance until blade replacement based on the current blade wear level and based on a maximum blade wear level configuration.

12. (canceled)

13. The surface saw according to claim 1, wherein the control unit is arranged to determine a difference between the current productivity level and an expected productivity level, and to trigger a notification in case the difference does not meet an acceptance criterion.

14. The surface saw according to claim 1, wherein the control unit is arranged to determine a difference between the current productivity level and an expected productivity level, wherein the control unit is arranged to control a drive unit of the surface saw based on the difference between the current productivity level and the expected productivity level.

15. The surface saw according to claim 1, wherein the control unit is arranged to determine a difference between the current productivity level and an expected productivity level, wherein the control unit is arranged to trigger a saw blade conditioning operation in case the difference between the current productivity level and the expected productivity level does not satisfy an acceptance criterion.

16. The surface saw according to claim 1, wherein the expected productivity level is configured in dependence of a circular cutting blade type mounted to the surface saw and/or in dependence of a current work task and/or in dependence of a maturity level of a concrete material in the surface

17. (canceled)

18. The surface saw according to claim 1, comprising an inertial measurement unit, IMU, arranged to output a signal indicative of a vibration of the surface saw, wherein the control unit is arranged to determine if the surface saw is in operation based on the output from the IMU, and to record the travelled distance by the surface saw only if the surface saw is in operation.

19. The surface saw according to claim 1, comprising a drive unit arranged to output a signal indicative of a torque applied to the circular saw blade and/or a signal indicative of a power consumption by the drive unit wherein the control unit is arranged to determine if the surface saw is in operation based on the torque output from the drive unit and/or based on the power consumption by the drive unit and to record the travelled distance by the surface saw only if the surface saw is in operation.

20. The surface saw according to claim 1, wherein the control unit is arranged to transmit data indicative of the recorded travelled distance by the surface saw to a remote server.

21. The surface saw according to claim 1, wherein the control unit is arranged to determine a remaining distance until work task completion, based on the recorded travelled distance and on a predetermined work task sawing distance.

22. The surface saw according to claim 1, wherein the control unit is arranged to determine a remaining time until work task completion, based on the recorded travelled distance on the current productivity level of the surface saw and on a predetermined work task sawing distance.

23-25. (canceled)

26. A computer-implemented method performed by a control unit arranged in a surface saw for sawing in a surface,
the surface saw comprising a circular cutting blade and at least one metering wheel,
the method comprising
arranging the metering wheel to rollably contact the surface and to output a signal indicative of a distance travelled by the surface saw during operation of the surface saw,
receiving, by the control unit, the signal from the metering wheel,
recording, by the control unit, the travelled distance by the surface saw during operation of the surface saw, and
determining a current productivity level of the surface saw by the control unit, wherein the current productivity level is indicative of a travelled distance per unit of time, based on the recorded travelled distance and on an associated elapsed period of time determined by a clock or timer circuit of the control unit.
